(19) United States
(12) Patent Application Publication
(10) Pub. No.: US 2022/0198058 A1
(43) Pub. Date: Jun. 23, 2022

(54) IDENTIFYING AND PREVENTING ACCESS TO AGGREGATE PII FROM ANONYMIZED DATA

(71) Applicant: LENOVO (Singapore) PTE. LTD., New Tech Park (SG)

(72) Inventors: Russell Speight VanBlon, Raleigh, NC (US); Robert Norton, Raleigh, NC (US); Robert J. Kapinos, Durham, NC (US); Scott Wentao Li, Cary, NC (US)

(21) Appl. No.: 17/129,081

(22) Filed: Dec. 21, 2020

(51) Int. Cl. G06F 21/62; G06F 21/36; G06K 9/62; G06N 20/00

(52) U.S. Cl. CPC G06F 21/6254; G06F 21/6227; G06N 20/00; G06K 9/6256; G06F 21/36

(57) ABSTRACT

Apparatuses, methods, systems, and program products are disclosed for identifying and preventing access to aggregate PII from anonymized data. An apparatus includes a processor and a memory that stores code executable by the processor. The code is executable by the processor to receive a query for a set of aggregated data associated with a plurality of users. The aggregated data set may include anonymized data for each user of the plurality of users. The code is executable by the processor to analyze a results data set for the query to determine an indication that at least one user of the plurality of users is identifiable from the results data set. The code is executable by the processor to prevent at least a portion of the results data set from being accessed in response to the indication that the at least one user is identifiable.

### FIELD

The subject matter disclosed herein relates to data privacy and security and more particularly relates to identifying and preventing access to aggregate PII from anonymized data.

### BACKGROUND

Personal data that is collected from a user may be anonymized to remove personally identifying information about the user from the data so that the data can be used without revealing the identity of the users behind the data. Data aggregation may be used to view a summary or total of user data instead of the raw data. With the right analysis, however, aggregate information may reveal personally identifying information about a user even though the raw data is anonymized.

### BRIEF SUMMARY

Apparatuses, methods, systems, and program products are disclosed for identifying and preventing access to aggregate PII from anonymized data. An apparatus, in one embodiment, includes a processor and a memory that stores code executable by the processor. The code, in certain embodiments, is executable by the processor to receive a query for a set of aggregated data associated with a plurality of users. The aggregated data set may include anonymized data for each user of the plurality of users. The code, in various embodiments, is executable by the processor to analyze a results data set for the query to determine an indication that at least one user of the plurality of users is identifiable from the results data set. In one embodiment, the code is executable by the processor to prevent at least a portion of the results data set from being accessed in response to the indication that the at least one user is identifiable.

A method for identifying and preventing access to aggregate PII from anonymized data, in one embodiment, includes receiving, by a processor, a query for a set of aggregated data associated with a plurality of users. The aggregated data set may include anonymized data for each user of the plurality of users. The method, in further embodiments, includes analyzing a results data set for the query to determine an indication that at least one user of the plurality of users is identifiable from the results data set. In certain embodiments, the method includes preventing at least a portion of the results data set from being accessed in response to the indication that the at least one user is identifiable.

A computer program product for identifying and preventing access to aggregate PII from anonymized data, in one embodiment, includes a computer readable storage medium having program instructions embodied therewith. In certain embodiments, the program instructions are executable by a processor to cause the processor to receive a query for a set of aggregated data associated with a plurality of users. The aggregated data set may include anonymized data for each user of the plurality of users. In some embodiments, the program instructions are executable by a processor to cause the processor to analyze a results data set for the query to determine an indication that at least one user of the plurality of users is identifiable from the results data set. In further embodiments, the program instructions are executable by a processor to cause the processor to prevent at least a portion of the results data set from being accessed in response to the indication that the at least one user is identifiable.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for identifying and preventing access to aggregate PII from anonymized data;

FIG. 2 is a schematic block diagram illustrating one embodiment of an apparatus for identifying and preventing access to aggregate PII from anonymized data;

FIG. 3 is a schematic block diagram illustrating one embodiment of another apparatus for identifying and preventing access to aggregate PII from anonymized data;

FIG. 4 is a schematic flow chart diagram illustrating one embodiment of a method for identifying and preventing access to aggregate PII from anonymized data; and

FIG. 5 is a schematic flow chart diagram illustrating one embodiment of another method for identifying and preventing access to aggregate PII from anonymized data.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. The code, in certain embodiments, is executable by the processor to receive a query for a set of aggregated data associated with a plurality of users. The aggregated data set may include anonymized data for each user of the plurality of users. The code, in various embodiments, is executable by the processor to analyze a results data set for the query to determine an indication that at least one user of the plurality of users is identifiable from the results data set. In one embodiment, the code is executable by the processor to prevent at least a portion of the results data set from being accessed in response to the indication that the at least one user is identifiable.

In one embodiment, the code is executable by the processor to analyze the results data set by performing one or more statistical analyses on the results data set to identify outlier data that uniquely identifies the at least one user. In certain embodiments, the code is executable by the processor to analyze the results data set by invoking at least one machine learning algorithm that is trained using training data comprising anonymized aggregated data for a plurality of users, the machine learning algorithm providing a prediction of the at least a portion of data that uniquely identifies the at least one user.

In one embodiment, the indication comprises a statistical value, a predicted value, and/or at least one record that indicates that the results data set comprises identifiable data for the at least one user. In some embodiments, the code is executable by the processor to prevent the at least a portion of the results data set from being accessed by removing at least one data record from the results data set that uniquely identifies the at least one user.

In various embodiments, the code is executable by the processor to prevent the at least a portion of the results data set from being accessed by rejecting the query and providing a message that the results data set for the query comprises identifiable information for the at least one user. In one embodiment, the code is executable by the processor to prevent the at least a portion of the results data set from being accessed by limiting a number of data records that are returned in the results data set to reduce a likelihood that the at least one user is identifiable.

In further embodiments, the code is executable by the processor to provide a message to an entity providing the query that explains that the results data set is not complete and that at least a portion of the results data set is removed due to exposing an identity of the at least one user, the message comprising the number of data records that are removed from the results data set.

In one embodiment, the code is executable by the processor to prevent the at least a portion of the results data set from being accessed based on permissions associated with an entity providing the query. In some embodiments, the code is executable by the processor to override preventing at least a portion of the results data set from being accessed in response to the entity providing the query having permissions to access the results data set.

In one embodiment, the code is executable by the processor to determine that the query comprises an aggregate query and to reject the query in response to the entity providing the query not having permissions to execute aggregate queries on the data set. In certain embodiments, the query is received at a database management system for data stored in a database, the code executable by the processor to intercept the results data set and remove the at least a portion of the results data set that uniquely identifies the at least one user.

A method for identifying and preventing access to aggregate PII from anonymized data, in one embodiment, includes receiving, by a processor, a query for a set of aggregated data associated with a plurality of users. The aggregated data set may include anonymized data for each user of the plurality of users. The method, in further embodiments, includes analyzing a results data set for the query to determine an indication that at least one user of the plurality of users is identifiable from the results data set. In certain embodiments, the method includes preventing at least a portion of the results data set from being accessed in response to the indication that the at least one user is identifiable.

In one embodiment, the method includes analyzing the results data set by performing one or more statistical analyses on the results data set to identify outlier data that uniquely identifies the at least one user. In some embodiments, the method includes analyzing the results data set by invoking at least one machine learning algorithm that is trained using training data comprising anonymized aggregated data for a plurality of users, the machine learning algorithm providing a prediction of the at least a portion of data that uniquely identifies the at least one user.

In certain embodiments, the method includes preventing the at least a portion of the results data set from being accessed by removing at least one data record from the results data set that uniquely identifies the at least one user. In some embodiments, the method includes preventing the at least a portion of the results data set from being accessed by rejecting the query and providing a message that the results data set for the query comprises identifiable information for the at least one user.

In one embodiment, the method includes preventing the at least a portion of the results data set from being accessed by limiting a number of data records that are returned in the results data set to reduce a likelihood that the at least one user is identifiable. In various embodiments, the method includes preventing the at least a portion of the results data set from being accessed based on permissions associated with an entity providing the query.

A computer program product for identifying and preventing access to aggregate PII from anonymized data, in one embodiment, includes a computer readable storage medium having program instructions embodied therewith. In certain embodiments, the program instructions are executable by a processor to cause the processor to receive a query for a set of aggregated data associated with a plurality of users. The aggregated data set may include anonymized data for each user of the plurality of users. In some embodiments, the program instructions are executable by a processor to cause the processor to analyze a results data set for the query to determine an indication that at least one user of the plurality of users is identifiable from the results data set. In further embodiments, the program instructions are executable by a processor to cause the processor to prevent at least a portion of the results data set from being accessed in response to the indication that the at least one user is identifiable.

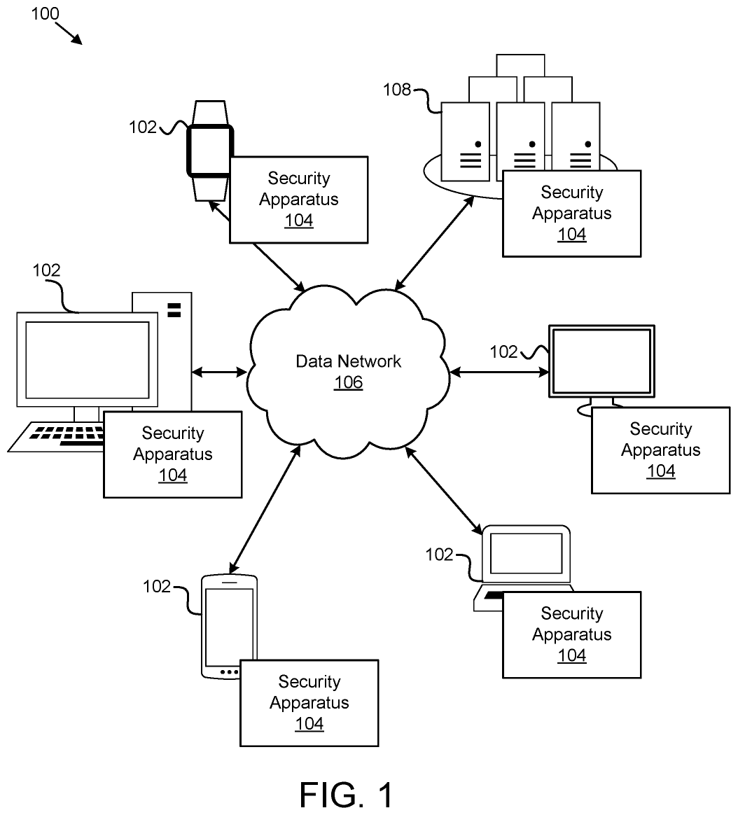

FIG. 1 is a schematic block diagram illustrating one embodiment of a system 100 for identifying and preventing access to aggregate PII from anonymized data. In one embodiment, the system 100 includes one or more information handling devices 102, one or more security apparatuses 104, one or more data networks 106, and one or more servers 108. In certain embodiments, even though a specific number of information handling devices 102, security apparatuses 104, data networks 106, and servers 108 are depicted in FIG. 1, one of skill in the art will recognize, in light of this disclosure, that any number of information handling devices 102, security apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like. In certain embodiments, the information handling devices 102 include components for receiving touch input, e.g., touch-enabled displays, and for providing audio sound, e.g., at least one speaker.

In general, in one embodiment, the security apparatus 104 is configured to identify and prevent access to personally identifying information based on aggregated information from an anonymized data set. In one embodiment, the security apparatus 104 is configured to receive a query for a set of aggregated data associated with a plurality of users. The aggregated data set comprises anonymized data for each user of the plurality of users. The security apparatus 104, in further embodiments, is configured to analyze a results data set for the query to determine an indication that at least one user of the plurality of users is identifiable from the results data set and prevent at least a portion of the results data set from being accessed in response to the indication that the at least one user is identifiable.

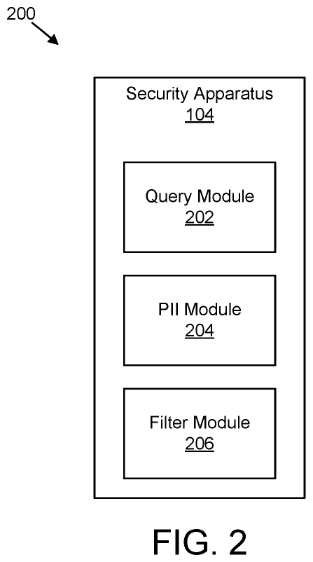

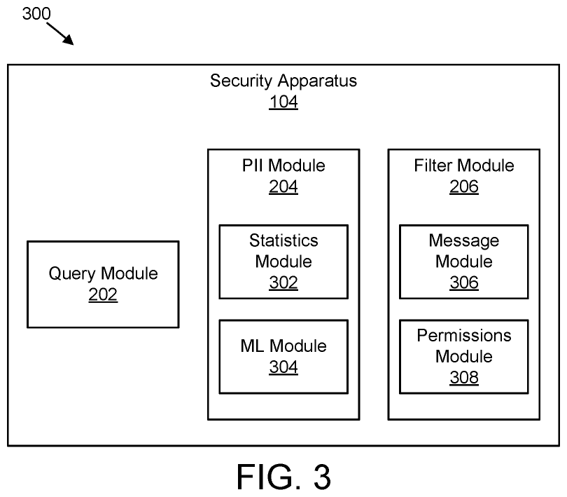

In this manner, the security apparatus 104 can identify aggregation-based PII and purge query results that include aggregation-based PII to protect the identity and sensitive information of a user. The security apparatus 104, including its various sub-modules, may be located on one or more information handling devices 102 in the system 100, one or more servers 108, one or more network devices, and/or the like. The security apparatus 104 is described in more detail below with reference to FIGS. 2 and 3.

In certain embodiments, the security apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the security apparatus 104 may include a power interface, a wired and/or wireless network interface, a graphical interface that attaches to a display, and/or a semiconductor integrated circuit device as described below, configured to perform the functions described herein with regard to the security apparatus 104.

The security apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the security apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the security apparatus 104.

The semiconductor integrated circuit device or other hardware appliance of the security apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the security apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may host, store, stream, or the like data such as user data, anonymized data, files, and content.

FIG. 2 is a schematic block diagram illustrating one embodiment of an apparatus 200 for identifying and preventing access to aggregate PII from anonymized data. In one embodiment, the apparatus 200 includes an instance of a security apparatus 104. In one embodiment, the security apparatus 104 includes one or more of a query module 202, a PII module 204, and a filter module 206, which are described in more detail below.

In one embodiment, the query module 202 is configured to receive a query for a set of aggregated data associated with a plurality of users. The aggregated data set comprises anonymized data for each user of the plurality of users. For instance, the aggregated data set may include data that has been stripped of personally identifiable information (“PII”) for each user. As used herein PII may refer to data that could potentially identify a specific individual such as names, addresses, credit card numbers, account numbers, usernames, and/or the like.

In one embodiment, the query is for a database and is received by the query module 202 as part of a database management system and is intended for data stored in a database that is managed by the database management system. For example, the query may be a Structured Query Language (“SQL”) query, or the like. The query module 202 may intercept the query and determine whether the user has permissions, see below, to run the query on the database; whether it is known that the query will result in retrieving PII from the aggregated data (e.g., based on previous runs of the same or similar queries); and/or the like. In this manner, the query module 202 can pre-process the query to decide whether to execute or deny the query prior to running it on the database, which saves time, power, processing cycles, and/or the like.

In one embodiment, the PII module 204 analyzes a results data set for the query to determine an indication that at least one user of the plurality of users is identifiable from the results data set. For instance, as described in more detail below, the PII module 204 may run various statistical analyses on the data to isolate and identify outlier anonymized data that may identify a user in the aggregate; may run the data through various machine learning or artificial intelligence algorithms to predict, estimate, forecast, and/or the like anonymized data that may identify a user in the aggregate; and/or the like. In such an embodiment, the indication that at least one user of the plurality of users is identifiable from the results data set includes a statistical value, a predicted value, and/or at least one data record that indicates that the results data set comprises identifiable data for the at least one user.

In one embodiment, the filter module 206 prevents at least a portion of the results data set from being accessed in response to the indication that the at least one user is identifiable. For instance, in one embodiment, the filter module 206 removes at least one data record, at least a portion of one data record, and/or the like from the results data set that uniquely identifies the at least one user. In such an embodiment, the filter module 206 may intercept the data results set, remove the data that can identify the user, and return the remainder of the results data set without the excluded data records, or portions of data records, that include anonymized data that may identify a user in the aggregate, e.g., when combined or aggregated with other data.

In further embodiments, the filter module 206 prevents the at least a portion of the results data set from being accessed by rejecting the query. For instance, the PII module 204 may determine that the query results in PII for at least one user, and may reject the query, e.g., not process the query, may return an empty results data set, and/or the like.

In such an embodiment, the filter module 206 may provide a message to notify a user or entity that submitted the query that the results data set for the query would include identifiable information for the at least one user and therefore is not accessible to the submitter.

In some embodiments, the filter module 206 prevents the at least a portion of the results data set from being accessed by limiting a number of data records that are returned in the results data set to reduce a likelihood that the at least one user is identifiable. In certain embodiments, a user may only be identifiable from aggregate anonymized data if the number of data records in the data results set is greater than or equal to a threshold number, e.g., 1,000 records. In such an embodiment, the filter module 206 may limit the number of data records that are used or returned to the query submitter to less than the threshold number.

In one embodiment, described in more detail below, the filter module 206 may determine whether to allow the results data set to be accessed in full, even if it contains PII for a user based on an aggregate of the anonymized data or prevent at least a portion of the results data set from being accessed by the query submitter based on permissions, credentials, roles, and/or the like of the query submitter. For instance, a user submitting a query that has a security clearance for confidential data may be allowed to access the full data results set, but a user with a lower level security clearance may only be allowed to access a data results set that does not include PII or data records that include anonymized data that can identify a user in the aggregate.

FIG. 3 is a schematic block diagram illustrating one embodiment of another apparatus 300 for identifying and preventing access to aggregate PII from anonymized data. In one embodiment, the apparatus 300 includes an instance of a security apparatus 104. The security apparatus 104, in certain embodiments, includes a query module 202, a PII module 204, and a filter module 206, which may be substantially similar to the query module 202, the PII module 204, and the filter module 206 described above with reference to FIG. 2. The security apparatus 104, in further embodiments, includes one or more of a statistics module 302, a ML module 304, a message module 306, and a permissions module 308, which are described in more detail below.

In one embodiment, the statistics module 302 analyzes the results data set by performing one or more statistical analyses on the results data set to identify outlier data that uniquely identifies the at least one user. The outlier data may be indicative of data records, or portions of data records, that do not fall within a normal distribution for the data such that the data is unique and may expose a user's identity. Various statistical methods or models may be used such as deviation aggregate, critical points, and/or the like, that provides an indication of a data record, result, or the like that may expose a user's identity or PII such as, for example, a data record identifier, a data record that is a number of standard deviations away from the median or mean, and/or the like.

In one embodiment, the statistics module 302 analyzes the data in the database while the data is at rest using previously executed queries, random queries, aggregate queries, and/or the like to statistically identify potential data records that may expose the user's identity or other PII. In certain embodiments, the statistics module 302 analyzes the data when a query is received to identify the like potential data records that may expose the user's identity or other PII in the results data set that may expose the user's identity or other PII.

In one embodiment, the ML module 304 analyzes the results data set by invoking at least one machine learning algorithm that is trained using training data comprising anonymized aggregated data for a plurality of users. The machine learning models that are used to identify the potentially identifier data may be trained using training data such as simulated data sets, real data sets, or the like that resemble, simulate, or the like the anonymized data in the data set/database, the types of anonymized data in the data set/database, and/or the like. Previously executed queries, predicted queries, random queries, and/or the like may be run against the training data to train the machine learning models to identify outlier data that may identify a user or expose a user's PII in the aggregate.

When placed in service, the trained machine learning model/algorithm may be run against the data in the database while the data is at rest using previously executed queries, random queries, aggregate queries, and/or the like to identify, predict, estimate, forecast, or the like potential data records that may expose the user's identity or other PII. In certain embodiments, trained machine learning model/algorithm may be run when a query is received to identify, predict, estimate, forecast, or the like potential data records that may expose the user's identity or other PII in the results data set that may expose the user's identity or other PII.

In one embodiment, the message module 306 is configured to provide a message to an entity providing the query that explains that the results data set is not complete and that at least a portion of the results data set has removed due to exposing an identity of the at least one user. In some embodiments, the message may include the number of data records that are removed from the results data set, the number of data records that the results data set is limited to, and/or the like.

In one embodiment, the permissions module 308 is configured to determine permissions for the entity providing the query. The permissions may include a security clearance, a role in an organization, a title, and/or other permissions that are assigned to a user, application, program, or other entity. In certain embodiments, the filter module 206 may prevent at least a portion of the results data set from being accessed based on permissions associated with an entity providing the query. For instance, a user's or program's permissions may only allow access to data that is public, but not confidential. Or data that is confidential, but not classified, and/or the like.

In such an embodiment, the query module 202 may determine that the query comprises an aggregate query and the permissions module 308 may reject the query in response to the entity, e.g., user or program providing the query not having permissions to execute aggregate queries on the data set. In this manner, the permissions module 308 may stop or halt execution of the query before the query is run against the data set and the data is potentially exposed to the entity

In some embodiment, the permissions module 308 may override preventing at least a portion of the results data set from being accessed in response to the entity providing the query having permissions to access the results data set. For instance, a user or program may have full access to the entire data set, including PII if the user/program has classified data access, or the like. In such an embodiment, if the filter module 206 by default prevents certain data from being accessed by a query submitter if the results of the query may expose a user's identity or PII for the user, the permission module 308 may override such default settings if the submitter's permissions allow access to the full results data set even if it may expose a user's identity or PII for the user.

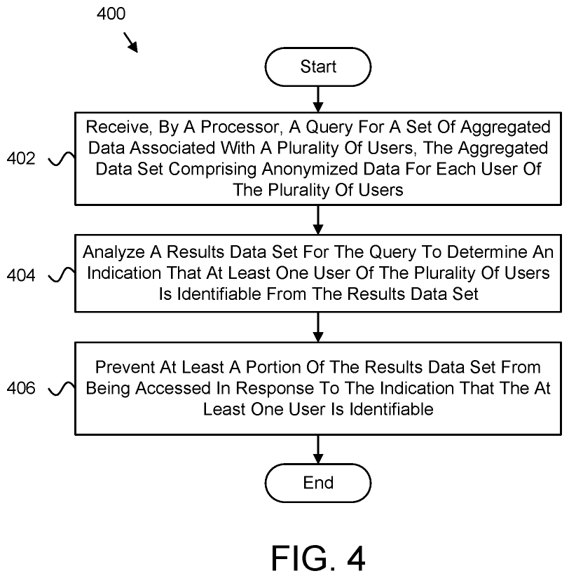

FIG. 4 is a schematic flow chart diagram illustrating one embodiment of a method 400 for identifying and preventing access to aggregate PII from anonymized data. In one embodiment, the method 400 begins and receives 402, by a processor, a query for a set of aggregated data associated with a plurality of users. The aggregated data set includes anonymized data for each user of the plurality of users.

In one embodiment, the method 400 analyzes 404 a results data set for the query to determine an indication that at least one user of the plurality of users is identifiable from the results data set. In certain embodiments, the method 400 prevents 406 at least a portion of the results data set from being accessed in response to the indication that the at least one user is identifiable, and the method 400 ends. In one embodiment, the query module 202, the PII module 204, and the filter module 206 perform the various steps of the method 400.

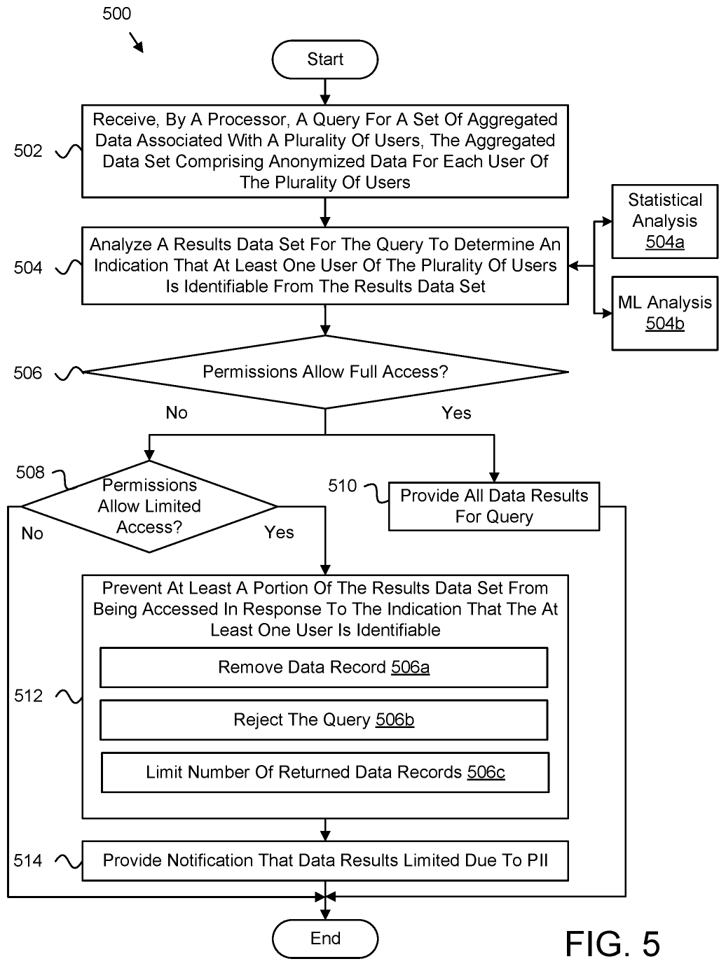

FIG. 5 is a schematic flow chart diagram illustrating one embodiment of a method 500 for identifying and preventing access to aggregate PII from anonymized data. In one embodiment, the method 500 begins and receives 502, by a processor, a query for a set of aggregated data associated with a plurality of users. The aggregated data set includes anonymized data for each user of the plurality of users.

In one embodiment, the method 500 analyzes 504 a results data set for the query to determine an indication that at least one user of the plurality of users is identifiable from the results data set. For instance, the method 500 may perform a statistical analysis 504a on the data and/or a machine learning analysis 504b on the data.

In further embodiments, the method 500 determines 506 whether the query submitter, e.g., a user or program, has permissions that allow full access to the data set. If so, the method 500 provides 510 the full data results set for the query and the method 500 ends.

Otherwise, the method 500 determines 508 whether the user's permissions allow for limited access to the results data. If not, the method 500 ends. Otherwise the method 500 prevents 512 at least a portion of the results data set from being accessed in response to the indication that the at least one user is identifiable. For instance, the method 500 may remove 506a data records, may reject 506b the query, and/or may limit 506c the number of data records that are returned or included in the data results set.

In such an embodiment, the method 500 provides 514 a message or notification that data results are limited due to potential exposure of a user's identity and/or PII, and the method 500 ends. In one embodiment, the query module 202, the PII module 204, the statistics module 302, the ML module 304, the filter module 206, the message module 306, and the permissions module 308 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
receive a query for a set of aggregated data associated with a plurality of users, the aggregated data set comprising anonymized data for each user of the plurality of users;
analyze a results data set for the query to determine an indication that at least one user of the plurality of users is identifiable from the results data set; and
prevent at least a portion of the results data set from being accessed in response to the indication that the at least one user is identifiable.

2. The apparatus of claim 1, wherein the code is executable by the processor to analyze the results data set by performing one or more statistical analyses on the results data set to identify outlier data that uniquely identifies the at least one user.

3. The apparatus of claim 1, wherein the code is executable by the processor to analyze the results data set by invoking at least one machine learning algorithm that is trained using training data comprising anonymized aggregated data for a plurality of users, the machine learning algorithm providing a prediction of the at least a portion of data that uniquely identifies the at least one user.

4. The apparatus of claim 1, wherein the indication comprises a statistical value, a predicted value, and/or at least one record that indicates that the results data set comprises identifiable data for the at least one user.

5. The apparatus of claim 1, wherein the code is executable by the processor to prevent the at least a portion of the results data set from being accessed by removing at least one data record from the results data set that uniquely identifies the at least one user.

6. The apparatus of claim 1, wherein the code is executable by the processor to prevent the at least a portion of the results data set from being accessed by rejecting the query and providing a message that the results data set for the query comprises identifiable information for the at least one user.

7. The apparatus of claim 1, wherein the code is executable by the processor to prevent the at least a portion of the results data set from being accessed by limiting a number of data records that are returned in the results data set to reduce a likelihood that the at least one user is identifiable.

8. The apparatus of claim 7, wherein the code is executable by the processor to provide a message to an entity providing the query that explains that the results data set is not complete and that at least a portion of the results data set is removed due to exposing an identity of the at least one user, the message comprising the number of data records that are removed from the results data set.

9. The apparatus of claim 1, wherein the code is executable by the processor to prevent the at least a portion of the results data set from being accessed based on permissions associated with an entity providing the query.

10. The apparatus of claim 9, wherein the code is executable by the processor to override preventing at least a portion of the results data set from being accessed in response to the entity providing the query having permissions to access the results data set.

11. The apparatus of claim 10, wherein the code is executable by the processor to determine that the query comprises an aggregate query and to reject the query in response to the entity providing the query not having permissions to execute aggregate queries on the data set.

12. The apparatus of claim 1, wherein the query is received at a database management system for data stored in a database, the code executable by the processor to intercept the results data set and remove the at least a portion of the results data set that uniquely identifies the at least one user.

13. A method, comprising:
receiving, by a processor, a query for a set of aggregated data associated with a plurality of users, the aggregated data set comprising anonymized data for each user of the plurality of users;
analyzing a results data set for the query to determine an indication that at least one user of the plurality of users is identifiable from the results data set; and
preventing at least a portion of the results data set from being accessed in response to the indication that the at least one user is identifiable.

14. The method of claim 13, further comprising analyzing the results data set by performing one or more statistical analyses on the results data set to identify outlier data that uniquely identifies the at least one user.

15. The method of claim 13, further comprising analyzing the results data set by invoking at least one machine learning algorithm that is trained using training data comprising anonymized aggregated data for a plurality of users, the machine learning algorithm providing a prediction of the at least a portion of data that uniquely identifies the at least one user.

16. The method of claim 13, further comprising preventing the at least a portion of the results data set from being accessed by removing at least one data record from the results data set that uniquely identifies the at least one user.

17. The method of claim 13, further comprising preventing the at least a portion of the results data set from being accessed by rejecting the query and providing a message that the results data set for the query comprises identifiable information for the at least one user.

18. The method of claim 13, further comprising preventing the at least a portion of the results data set from being accessed by limiting a number of data records that are returned in the results data set to reduce a likelihood that the at least one user is identifiable.

19. The method of claim 13, further comprising preventing the at least a portion of the results data set from being accessed based on permissions associated with an entity providing the query.

20. A computer program product, comprising a computer readable storage medium having program instructions embodied therewith, the program instructions executable by a processor to cause the processor to:
receive a query for a set of aggregated data associated with a plurality of users, the aggregated data set comprising anonymized data for each user of the plurality of users;
analyze a results data set for the query to determine an indication that at least one user of the plurality of users is identifiable from the results data set; and
prevent at least a portion of the results data set from being accessed in response to the indication that the at least one user is identifiable.
